(19) United States
(12) Patent Application Publication
(10) Pub. No.: US 2022/0126412 A1
(43) Pub. Date: Apr. 28, 2022

(54) CLAMPING DEVICE

(71) Applicant: cutpack.com GmbH, Fussach (AT)

(72) Inventor: Remo EGGER, Langenegg (AT)

(73) Assignee: cutpack.com GmbH, Fussach (AT)

(21) Appl. No.: 17/423,173

(22) PCT Filed: Jan. 10, 2020
(86) PCT No.: PCT/EP2020/050515

§ 371 Date: Jul. 15, 2021

(30) Foreign Application Priority Data
Jan. 17, 2019 (AT) A 20/2019

(51) Int. Cl. B23Q 1/00; B25B 5/10

(52) U.S. Cl. CPC B23Q 1/0072; B23Q 2703/06; B25B 5/10

(57) ABSTRACT

A clamping device for clamping an insertion nipple (7), including a clamping element (11) which can be axially moved, by a drive motor (9) via a screw mechanism (13), between an open position in which the insertion nipple (7) can be introduced into a receiving opening (8) of the clamping device and withdrawn from the same, and a clamping position in which the insertion nipple (7) introduced into the receiving opening (8) is retained in the same. The clamping device has an impulse unit (12) with a rotary part (40) which is mechanically coupled to the rotor (31) of the drive motor (9), and by which, for each revolution, a rotary impulse can be transmitted, at least once, to an impulse-receiving part (41) of the impulse unit (12) via the screw mechanism (13), in order to axially move the clamping element (11).

### TECHNICAL FIELD

The invention relates to a clamping device for clamping an insertion nipple, comprising a clamping element which is axially adjustable, by a drive motor via a screw mechanism, between an open position in which the insertion nipple is able to be introduced into a receptacle opening of the clamping device and extracted from the latter, and a clamping position in which the insertion nipple introduced into the receptacle opening is retained in the latter.

### BACKGROUND

Clamping devices, also referred to as clamping systems, serve for fixing a workpiece in order for the latter to be machined at a workstation and/or for the latter to be transferred from one workstation to the next. In the case of a zero-point clamping device, the position of the workpiece here is established in relation to three axes. Clamping devices in which establishing only takes place in relation to one axis (“z-fixing”) are also known.

In a conventional configuration, the workpiece or a support that supports the workpiece, in most instances referred to as a pallet, has at least one insertion nipple which in the closed state of the clamping device is held in a receptacle opening of the clamping device. To this end, the insertion nipple has at least one annular groove in which engagement elements, for example clamping balls, engage in the closed state of the clamping device. When high clamping forces are desired, hydraulic motors usually have to be used.

A clamping device of the type mentioned at the outset is derived from WO 2014/044390 A1. In a clamping position of a clamping element, clamping balls are pushed into the annular groove of the insertion nipple that is introduced into the receptacle opening, and the clamping device is thus closed. In order for the clamping device to be opened, the clamping element is axially adjusted from the clamping position to an open position in which the clamping balls can disengage from the annular groove. The axial adjustment of the clamping element between the clamping position and the open position takes place by a drive motor by way of a screw mechanism. The screw mechanism has a stationary outer part having an internal thread, said outer part being formed by a housing part of the clamping device. The external thread of an inner part of the screw mechanism engages with the internal thread of this outer part, said inner part in turn being connected to the clamping element. The rotatable inner part of the screw mechanism is driven by the drive motor by way of a dual-stage planetary gear mechanism. This planetary gear mechanism thus has to be configured so as to be height-adjustable conjointly with the rotatable inner part of the screw mechanism. Overall, this leads to a complicated construction. With a view to the static and dynamic friction that arises, the drive motor has to be controlled in terms of torque and rotating speed. The attainable cycle time for a complete clamping and releasing procedure is comparatively long. The ratio between the clamping output applied and the drive output of the drive motor introduced is relatively small.

### SUMMARY

It is an object of the invention to provide an advantageous clamping device of the type mentioned at the outset which enables a high clamping force. According to the invention, this is achieved by a clamping device having one or more of the features disclosed herein.

The clamping device according to the invention has an impulse unit which possesses a rotating part which is mechanically coupled to the rotor of the drive motor. From the rotating part, a rotary impulse can be transmitted, at least once per revolution, to an impulse receiver part of the impulse unit, as a result of which the axial adjustment of the clamping element by way of the screw mechanism takes place. In one advantageous embodiment of the invention, the rotating part is disposed in a receptacle space of the impulse receiver part. The impulse receiver part here can advantageously be directly the rotatable part of the screw mechanism, thus have a thread, preferably an external thread, which engages with the thread, preferably an internal thread, of a non-rotatable part of the screw mechanism. The non-rotatable part of the screw mechanism here can also be axially non-displaceable such that the impulse receiver part is axially adjusted in a rotation about the longitudinal central axis of the impulse unit. The non-rotatable and axially non-displaceable part of the screw mechanism is preferably a housing part of the clamping device. However, it would also be conceivable and possible for the rotatable part of the screw mechanism to be a separate part which is mechanically coupled to the impulse receiver part.

The transmission of the rotary impulse to the impulse receiver part of the impulse unit thus does not take place continuously but intermittently. In other words, a torque is intermittently exerted on the impulse receiver part by the continuously driven rotating part of the impulse unit. For each revolution of the rotating part, a torque is thus exerted on the impulse receiver part at least once across a range of the rotary angle of the rotating part that is less than 90°, while no torque is exerted on the impulse receiver part across the remaining range of the rotary angle of the rotating part.

The transmission of the rotary impulse can take place mechanically by way of two ramps that run on to one another. In one preferred embodiment of the invention, the transmission of the rotary impulse however takes place hydraulically.

Impulse units of this type are conventionally used in impulse drivers or impact drivers. Impact drivers having hydraulic transmission of the rotary impulse are derived from, for example, EP 1 502 707 A2, DE 10 2007 045 695 A1, and EP 1 920 887 A1. An impulse impact unit, in particular for an impulse driver, is derived from DE 43 43 582 A1, wherein transmission of the rotary impulse from the rotating part to the impulse receiver part takes place mechanically. The impulse receiver part here has a lifting piston which in an oil bath is radially displaceable counter to the force of a restoring spring, the rotating part running onto the lifting piston.

As a result of the configuration according to the invention, a very high clamping force can be applied in an effective manner. In order for a high clamping force to be applied here, a hydraulic motor is not necessarily required as a drive motor, but such a high clamping force can also be achieved by an electric drive motor.

In one advantageous embodiment of the invention, the rotor of the drive motor is connected to the rotating part of the impulse unit so as not to be axially displaceable, and is axially displaceable in relation to the stator of the drive motor. A simple but nevertheless robust configuration is enabled as a result. The drive motor can in particular be an electric external rotor motor. Such an electric external rotor motor can preferably be configured so as to be brushless. The rotor here can favorably have permanent magnets. The latter preferably have a larger axial extent than the coils of the stator. It is thus enabled that portions of the permanent magnets lie opposite the stator across the entire axial extent of the coils of the stator, specifically at different axial positions of the rotor.

The connection of the rotating part of the impulse unit to the rotor of the drive motor preferably takes place directly by way of a drive shaft that is driven by the rotor of the drive motor. Said drive shaft can be integrally molded on the rotating part of the impulse unit, for example, or be rigidly fastened to the latter, and be received in an opening of the rotor. It is also conceivable and possible for the drive shaft to be integrally molded on the rotor, or fastened to the latter, and received in an opening of the rotating part. The drive shaft here has in each case a cross-sectional shape that deviates from the circular shape, and the opening receiving the drive shaft has a corresponding cross-sectional shape.

The clamping device advantageously has a sensor for detecting the axial position of the rotating part of the impulse unit. To this end, a limit switch which is activatable by that part that is connected to the drive shaft that drives the rotating part, or else is activatable by the end of the drive shaft itself, can in particular be provided.

### BRIEF DESCRIPTION OF THE DRAWINGS

Further advantages and details of the invention will be explained hereunder by the appended drawing, in which:

FIGS. 1 and 2 show a plan view and a lateral view of a clamping device according to one exemplary embodiment of the invention, having an insertion nipple introduced in the receptacle opening, in the open state of the clamping device, thus in the open position of the clamping element;

FIG. 3 shows a section along the line AA of FIG. 1;

FIG. 4 shows a section analogous to that of FIG. 3, but in an intermediate position of the clamping element;

FIG. 5 shows a section analogous to that of FIG. 3, but in the closed state of the clamping device, thus in the clamping position of the clamping element;

FIG. 6 shows a section analogous to that of FIG. 3, but without the insertion nipple, and in a terminal position of the clamping element;

FIG. 7 shows a section along the line BB of FIG. 2;

FIG. 8 shows a sectional exploded illustration;

FIG. 9 shows a section corresponding to that of FIG. 5, for a somewhat modified embodiment;

FIG. 10 shows a section corresponding to that of FIG. 6, for a further exemplary embodiment of the invention; and

FIG. 11 shows a section along the line CC of FIG. 10.

### DETAILED DESCRIPTION

The figures are to different scales.

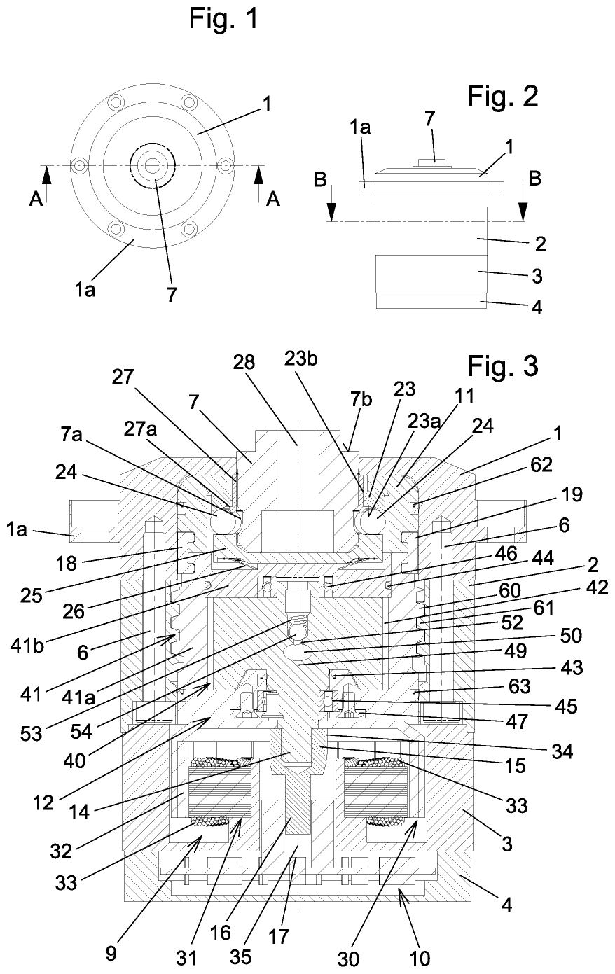

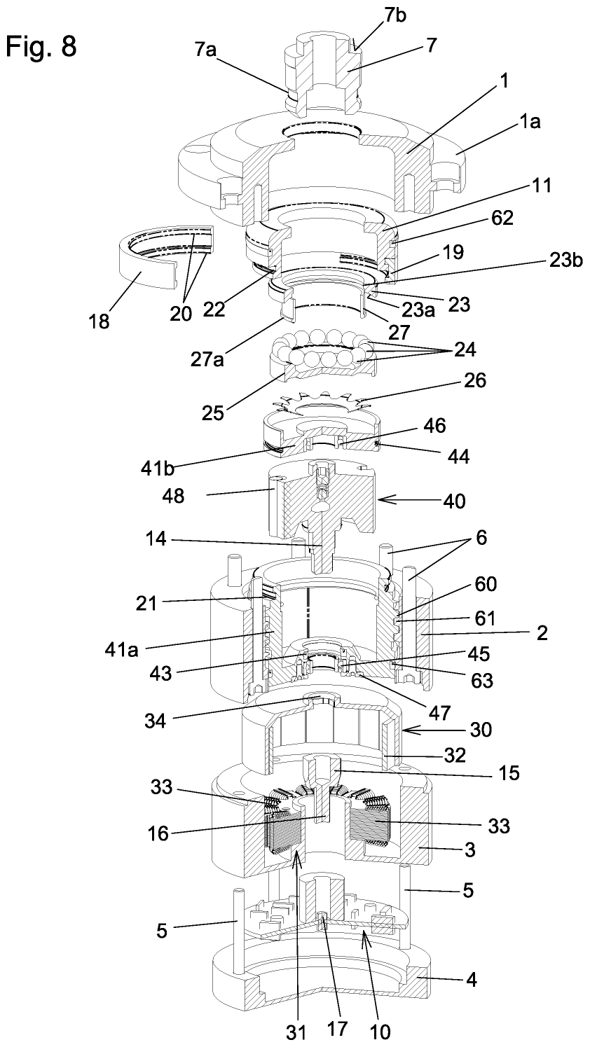

An exemplary embodiment of a clamping device according to the invention is illustrated in FIGS. 1 to 8, in some instances simplified.

The clamping device has a housing which is formed by a plurality of housing parts, in the exemplary embodiment by four housing parts 1 to 4, which are connected to one another by screws 5, 6.

An insertion nipple 7 is able to be introduced into a receptacle opening 8 of the clamping device through an opening in the housing part 1 and is able to be braced in said receptacle opening 8, as will be explained hereunder.

The housing part 1 can be fastened to another machine part by a screw flange 1a.

An electric drive motor 9 which comprises a stator 30 and a rotor 31, the latter being rotatable about the longitudinal central axis 35 of the drive motor 9, serves for opening and closing the clamping device. The actuation of the drive motor 9 takes place by an electronic control unit 10. A circuit board which is equipped with electronic components and held in the housing part 4 is schematically indicated here.

The drive motor in the exemplary embodiment is configured in the form of a brushless external rotor motor, wherein the rotor 31 is equipped with permanent magnets 32. The stator 30 is configured so as to be integral to the housing part 3. To this end, the external casing of the housing part 3 by way of a connecting web is connected to a cylindrical inner part which supports the coils 33 of the stator 30.

The drive motor 9 serves for the axial adjustment of a clamping element 11 between an open position in which the clamping device is opened, cf. FIG. 3, and a clamping position in which the clamping device is closed and the insertion nipple is braced in the receptacle opening 8, cf. FIG. 5. The axial adjustment of the clamping element 11 takes place by way of an impulse unit 12 and a screw mechanism 13.

The impulse unit 12 has a rotating part 40 which is rotatable about a longitudinal central axis 49 of the impulse unit 12 and is mechanically coupled to the rotor 31 of the drive motor 9. In a rotation of the rotor 31 of the drive motor 9, the rotating part 40 is thus continuously rotated about the longitudinal central axis 49, whereby the longitudinal central axis 49 of the impulse unit 12 and the longitudinal central axis 35 of the drive motor 9 in the exemplary embodiment lie on a common straight line, as is preferable.

The mechanical connection between the rotor 31 of the drive motor 9 and the rotating part 40 of the impulse unit 12 in the exemplary embodiment takes place directly by way of a drive shaft 14 which is integrally molded on the rotating part 40. The drive shaft 14 in one portion has a contour that deviates from the circular shape and by way of this portion protrudes into an opening 34 of the rotor 31 that has a corresponding contour. That portion of the drive shaft 14 that protrudes from the rotor 31 on the other side of the opening 34 has an external thread. A nut 15 having an integrally molded trigger pin 16 for a limit switch 17 is screwed onto said external thread.

The impulse unit 12 furthermore has an impulse receiver part 41 which is likewise rotatable about the longitudinal central axis 49. This impulse receiver part 41 possesses a sealed receptacle space 42 in which the rotating part 40 is received. The receptacle space 42 is moreover filled with a hydraulic fluid which is not separately illustrated in the figures.

The impulse receiver part 41 in the exemplary embodiment comprises a pot-shaped main part 41a and a cover 41b. The base of the main part 41a has an opening through which the drive shaft 14 is guided through in a sealed manner by a seal 43. The cover 41b by a seal 44 is likewise sealed in relation to the main part 41a. Furthermore, ball bearings 45, 46 by which the rotating part 40 is rotatably mounted are disposed in the region of the opening of the base of the main part 41a and in a depression in the cover 41b. The ball bearing 45 surrounds the drive shaft 14 and the ball bearing 46 surrounds a journal-shaped appendage of the rotating part 40. A retaining ring 47 screwed to the base serves for mounting the ball bearing 45 on the base of the main part 41a.

The impulse receiver part 41 could also be configured in a modified manner. A pot-shaped part which forms the casing and the cover of the impulse receiver part and which is closed by a separate base which is sealed in relation to the pot-shaped part could thus be provided, said pot-shaped part having the opening for passing through the drive shaft 14.

As is known from impulse drivers, the receptacle space 42 when viewed in the cross section (FIG. 7) is not delimited in a circular manner, but is somewhat elongate (oval) in one direction in comparison to the circular shape. The rotating part has a circular external contour. There is thus a gap present between the rotating part 40 and the impulse receiver part 41, said gap being of variable width across the circumference of the rotating part 40, cf. FIG. 7. The gap possesses the smallest width thereof at two opposite locations of the impulse receiver part, and the gap possesses the largest width thereof at two locations which in comparison are spaced apart by 90°, cf. FIG. 7. The gap between the rotating part 40 and the impulse receiver part 41 at two opposite locations of the rotating part 40 is in each case bridged by a sealing element 48, that is to say that the rotating part 40 at these opposite locations is at least largely sealed in relation to the wall of the impulse receiver part 41 that delimits the receptacle space 42. The sealing elements 48 can be formed by cylindrical bodies, for example, which are disposed in grooves in the casing of the rotating part 40. These cylindrical bodies are pushed against the wall of the impulse receiver part 41 as a result of the rotation of the rotating part 40.

Moreover disposed in the rotating part 40 are ducts 50, 51 which serve for transmitting the hydraulic fluid between the gap spaces which are sealed by the sealing elements 48. These ducts 50, 51 in FIG. 7 are indicated by dashed lines and run at different height levels in the rotating part 40. The duct 50 runs between the grooves in which the sealing elements 48 are disposed. The duct 51 runs so as to be orthogonal thereto. The ducts 50, 51 are connected to one another by an axially running connecting duct 52, cf. FIG. 3, for example. The connecting duct here is closed by a preferably spherical closure member 54 which is impinged by a spring 53. When a threshold value of the pressure of the hydraulic fluid in the duct 50 is exceeded, the hydraulic fluid can flow into the duct 51 while lifting the closure member 54. The torque exerted is a function of the preloading of the spring 53. The preloading of the spring can be configured so as to be adjustable by a set screw. Instead of a closure member 54 which is impinged by a spring 53, it could also be provided, for example, for the connecting duct 52 to be configured with a correspondingly small flow cross section such that the latter acts as a throttle.

In the rotation of the rotating part 40, the hydraulic fluid situated in the gap between the rotating part 40 and the impulse receiver part 41 is thus in each case impinged by a pressure when the respective sealing element 48 reaches the end of the oval-convex region of the impulse receiver part 41, wherein hydraulic fluid, at least upon exceeding a threshold value of the pressure, can flow through a gap between the sealing element 48 and the rotating part 40 into the duct 50, and onward by way of the connecting duct 51 into the duct 51, and from there into one of the gap spaces between the rotating part 40 and the impulse receiver part 41 that is not impinged with pressure.

In the rotation of the rotating part 40 by the drive motor 9 for adjusting the clamping element 11, an exertion of torque by the rotating part 40 on the impulse receiver part 41, and thus a transmission of a rotary impulse from the rotating part 40 to the impulse receiver part 41, therefore takes place twice in each revolution of the rotating part 40 in the exemplary embodiment.

Only one sealing element, which is disposed on the rotating part, for sealing the gap between the rotating part 40 and the impulse receiver part 41 could also be provided, for example, such that a transmission of the rotary impulse arises only once per revolution, or more than two such sealing elements could be provided such that a corresponding number of transmissions of a rotary impulse takes place per revolution.

As a result of the repeated transmission of a rotary impulse to the impulse receiver part 41, the latter is rotated about the longitudinal central axis 49 of the impulse unit 12 so as to adjust the clamping element 11 between the open position and the clamping position. The rotating movement of the impulse receiver part 41 here is converted to an axial movement, thus to a movement parallel to the longitudinal central axis of the screw mechanism 13, by the screw mechanism 13, wherein the longitudinal central axis of the screw mechanism 13 coincides (i.e. is on a common straight line) with the longitudinal central axis 49 of the impulse unit 12. To this end, the impulse receiver part 41 in the exemplary embodiment is itself provided with an external thread 60 which interacts with an internal thread 61 of the housing part 13. The internal thread 61 of the housing part 13 guides the rotation of the impulse receiver part 41 about the longitudinal central axis 49. The internal thread 61 thus also keeps the rotating part 40 so as to be concentric with the longitudinal central axis 49 of the impulse unit 12. As a result thereof, the rotor 31 in the exemplary embodiment is also kept so as to be concentric to the longitudinal central axis 35 of the drive motor 9, whereby any other configuration is also possible.

For example, the housing part 13 having the internal thread 61 can be configured from bronze so as to configure positive frictional properties in relation to the impulse receiver part 41, the latter being composed of steel.

In the exemplary embodiment, that part of the screw mechanism 13 that is set in rotation is thus simultaneously that part that is displaced axially (i.e. parallel to the longitudinal central axis 49) by the rotating movement.

As has already been mentioned, the rotating part 40 of the impulse unit 12 is connected to the rotor 31 of the drive motor 9 so as not to be axially displaceable (in terms of the longitudinal central axis 49 of the impulse unit 12, or the longitudinal central axis 35 of the drive motor 9). In an axial adjustment of the impulse receiver part 41, the rotor 31 in relation to the stator 30 thus moves in the axial direction (i.e. parallel to the longitudinal central axis 35). In order for portions of the permanent magnets 32 of the rotor 31 to be axially opposite the coils 33 of the stator 30 at all axial positions of the rotor 31 relative to the stator 30, the permanent magnets 32 have a larger axial extent than the coils 33, cf. FIGS. 3 to 6.

The opening and the closing of the clamping device takes place as a result of the axial movement of the impulse receiver part 41 caused by the screw mechanism 13. To this end, the impulse receiver part 41 is connected to the clamping element 11 so as not to be axially displaceable. To this end, two half rings 18, 19, which have in each case two projecting webs 20 which are axially spaced apart, are provided in the exemplary embodiment. One of the webs 20 of a respective half ring 18, 19 engages in each case in a groove 21 on the external side of the main part 41a of the impulse receiver part 41, and the other engages in a groove 22 on the external side of the clamping element 11. Modified configurations are conceivable and possible. For example, an integral configuration of the impulse receiver unit 41 and the clamping element 11 would also be conceivable and possible.

In order for the clamping device to be closed, a clamping ring 23 is pulled against clamping balls 24 by the clamping element 11 which in the exemplary embodiment is configured as a puller sleeve. The clamping ring 23 is thus displaced axially in the direction toward the clamping balls 24 by the clamping element 11. The clamping ring 23 here has a ramp 23a which interacts with the clamping balls 24. When the clamping ring 23 having the ramp 23a is pulled against the clamping balls 24, the clamping balls 24 are pushed radially inward into an annular groove 7a of the insertion nipple 7. The clamping balls 24 thus form engagement elements which interact with the annular groove 7a of the insertion nipple 7 so as to fix the insertion nipple 7 in the receptacle opening 8.

The clamping balls 24 bear on a washer 25 which is disposed between the clamping balls 24 and the impulse receiver part 41. A spring 26 is disposed between the washer 25 and the impulse receiver part 41, said spring 26 exerting on the washer 25 a preloading force that acts in the direction toward the clamping balls 24. The spring 26 here is configured in the manner of a cup spring.

The spring 26 is supported on the cover 41b of the impulse receiver part 41.

An aperture ring 27 is furthermore disposed on that side of the clamping balls 24 that faces away from the drive motor 9. Said aperture ring 27 extends radially within the clamping ring 23 across an end portion that faces the clamping balls 24. The aperture ring 27 here interacts with the clamping balls 24 radially within the location where said clamping balls 24 have the largest extent thereof in terms of the axial direction of the clamping device.

In the opened state of the clamping device, the aperture ring 27 is pushed against the internal side of the housing part 1 in the region that surrounds the opening in the housing part 1, this action taking place specifically as a result of the force of the spring 26 which acts on the aperture ring 27 by way of the washer 25 and the clamping balls 24. A minor gap can be present here between the washer 25 and the cover 41b. As a result thereof, the clamping balls 24 are pushed radially outward by the aperture ring 27, thus out of the annular groove 7a of the insertion nipple 7, cf. FIG. 3. In this position, the insertion nipple 7 is able to be introduced through the opening in the housing part 1 into the receptacle opening 8 and be extracted from the latter, specifically in a manner parallel to the longitudinal central axis 28 of the receptacle opening 8. The longitudinal central axis 28 of the receptacle opening 8 and the longitudinal central axis 49 of the impulse unit 12 lie on a common straight line, as is preferable.

In order for the insertion nipple 7 to be clamped in the receptacle opening, the insertion nipple 7 in the open position of the clamping element 11 is first introduced into the receptacle opening 8 until said insertion nipple 7 bears on the washer 25, as is illustrated in FIG. 3.

Consequently, the clamping element 11 by the drive motor 9 is axially adjusted (i.e. displaced parallel to the longitudinal central axis 28 of the receptacle opening 8) from the open position in the direction toward the clamping position by way of the impulse unit 12 and the screw mechanism 13.

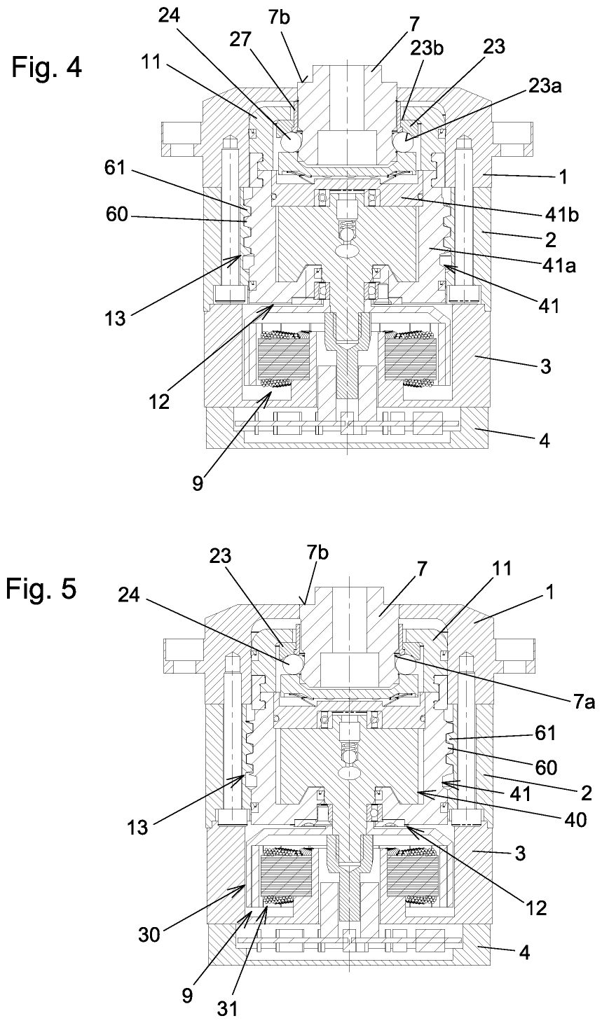

An intermediate position is illustrated in FIG. 4. When the clamping element 11 is being repositioned, proceeding from the open position thereof in the direction of the clamping position thereof, the clamping ring 23 is pulled against the clamping balls 24. Because the clamping balls 24 are simultaneously pulled away from the opening in the housing part 1, the contact pressure force that acts on the aperture ring 27 is cancelled on the housing part 1, and said aperture ring 27 can lift away from the housing part 1. As a result of the ramp 23a of the clamping ring 23, the clamping balls 24 are pushed inward, into the annular groove 7a of the insertion nipple 7. The spacing between the clamping ring 23 and the washer 25 here is somewhat reduced such that the washer 25 can also lift somewhat away from the cover 41b, cf. FIG. 4. FIG. 4 shows a snapshot of the position of the clamping element 11 in which the clamping balls 24 are pushed into the annular groove 7a and bear on the lower (i.e. distal from the opening in the housing part 1) periphery of the annular groove 7a. In the continuing adjustment of the clamping element 11 in the direction toward the clamped position, the insertion nipple 7 is thus entrained by the clamping balls 24 and axially adjusted, wherein said insertion nipple 7 is further pulled into the receptacle opening 8. The closed state of the clamping device, in which the clamping element 11 is situated in the clamping position, is illustrated in FIG. 5. The insertion nipple 7 has been pulled into the receptacle opening 8 just to the extent that the stepped face 7b, which lies so as to be orthogonal to the longitudinal central axis 28 of the receptacle opening 8 and where the insertion nipple 7 has a stepped reduction of the diameter of the latter to a smaller diameter, lies so as to be flush with the external surface of the housing part 1 that likewise lies so as to be orthogonal to the longitudinal central axis 28 of the receptacle opening 8. The insertion nipple 7 is attached to a workpiece to be machined, or to a support for a workpiece to be machined (i.e. workpiece pallet). This workpiece, or this support, respectively, is not illustrated in the figures but bears on the stepped face 7b and from the latter extends in a planar manner toward the outside. The further introduction of the insertion nipple 7 in the clamping position of the clamping element 11 illustrated in FIG. 5 is thus blocked as a result of the surface of the workpiece, or the support for a workpiece to which the insertion nipple 7 is fastened, respectively, bearing on the external side of the housing part 1. The insertion nipple 7 is thus held by way of a high clamping force in a defined position in terms of the axial direction of the clamping device (i.e. direction of the longitudinal central axis 28 of the receptacle opening 8, also referred to as the “z-direction”).

In the closed state of the clamping device, a tight fit, preferably a press fit, is present between the insertion nipple 7 and the opening in the housing part 1 so that the position of the insertion nipple 7 is also defined in terms of two directions which are mutually perpendicular and lie so as to be orthogonal to the axial direction of the clamping device. A zero-point clamping device (zero-point clamping system) is implemented in this way.

The aperture ring 27 also serves for preventing the clamping balls 24 from dropping out in a radially inward manner when the clamping element 11, in the absence of an introduced insertion nipple 7, is displaced from the open position to the clamping position and beyond. To this end, the opening ring 27 has a radially outwardly projecting annular protrusion 27a which is provided for interacting with a shoulder 23b of the clamping ring 23. In the open position of the clamping element 11, the shoulder 23b of the clamping ring 23 is lifted from the protrusion 27a of the opening ring 27, cf. FIG. 3. When the clamping element 11 is repositioned in the direction of the clamping position of the latter, the protrusion 27a of the aperture ring 27 comes to bear on the shoulder 23b of the clamping ring 23. Consequently, the aperture ring 27 is entrained by the clamping ring 23, cf. FIGS. 4 and 5. In this position, the spacing between the aperture ring 27 and the washer 25 is still somewhat smaller than the diameter of the clamping balls 24.

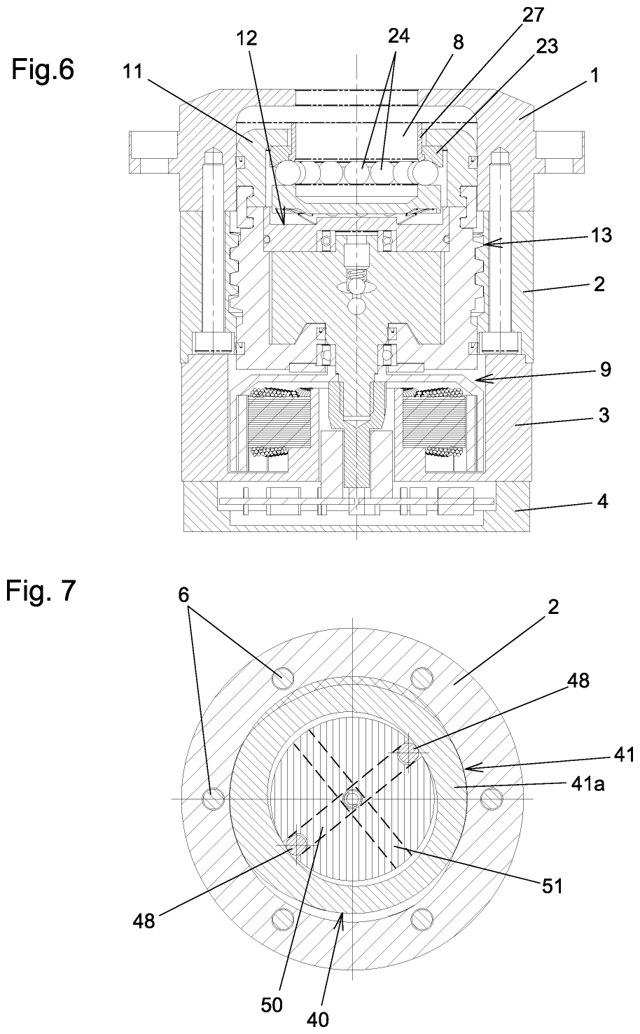

FIG. 6 shows the state of the clamping device in which the clamping element 11 is repositioned beyond the clamping position to the terminal position thereof which is opposite the open position, specifically without the insertion nipple 7 being inserted in the receptacle opening 8. This terminal position is predefined by the response of the limit switch 17. Moving to this terminal position serves as a reference movement for controlling the clamping device by the control unit 10.

Seals 62, 63 for preventing an ingress of dirt into the screw mechanism are disposed on both sides of the threads 60, 61 of the screw mechanism 13.

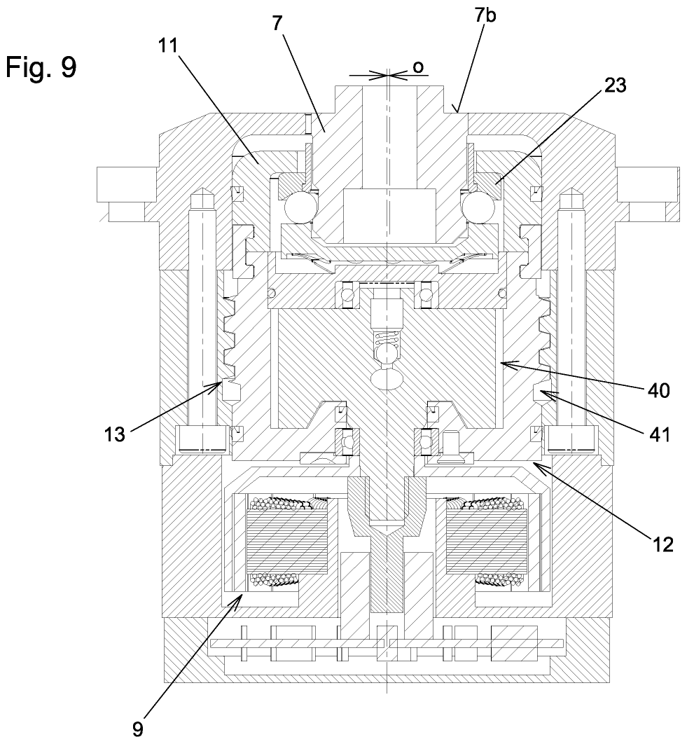

FIG. 9 shows a modification of the exemplary embodiment illustrated in FIGS. 1 to 8 to the effect that the insertion nipple 7 in terms of the alignment orthogonal to the axial direction has a clearance, that is to say is somewhat adjustable in the x-direction and the y-direction. To this end it is sufficient for the opening in the housing part 1 to be configured so as to be correspondingly larger than the diameter of the insertion nipple 7. The unit comprising the clamping ring 23, the aperture ring 27, the clamping balls 24 and the washer 25, optionally also the spring 26, can here be displaced in the direction orthogonal to the axial direction in relation to the clamping element 11 and the impulse receiver part 41 in a manner corresponding to the position of the insertion nipple orthogonal to the axial direction (offset o).

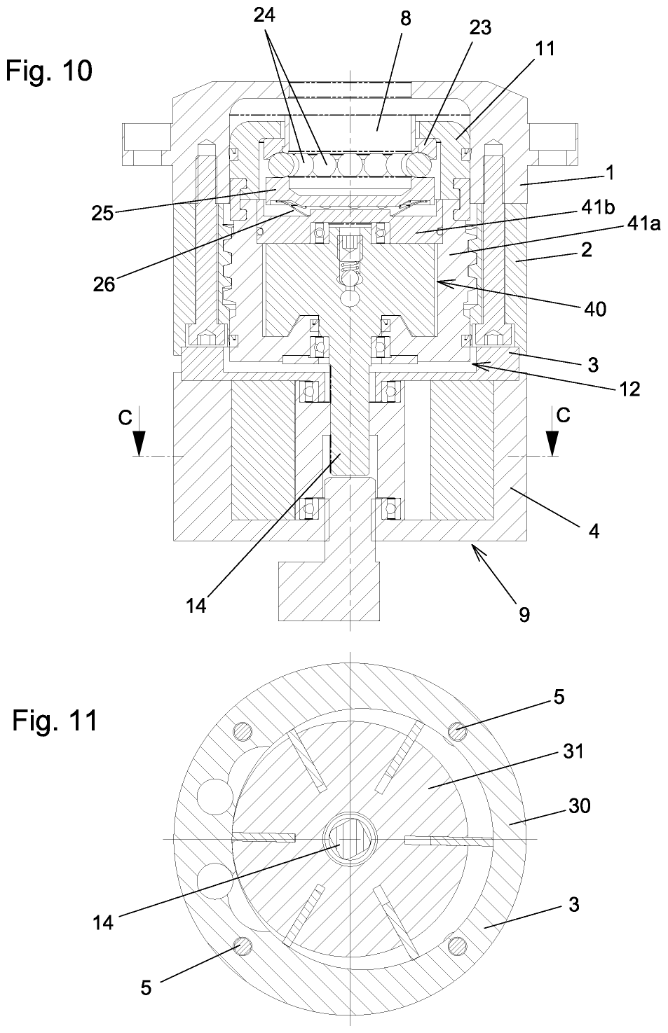

A further exemplary embodiment is illustrated in FIGS. 10 and 11. With the exception of the variations described hereunder, the configuration corresponds to that of the first exemplary embodiment and the description pertaining to the first exemplary embodiment can be referred to in an analogous manner. The drive motor 9 in this exemplary embodiment is configured as a pneumatic motor. The rotor 31 here is not axially displaceable. The drive shaft 14 is connected to the rotor 31 in a rotationally fixed but axially displaceable manner.

Various modifications of the exemplary embodiments shown are conceivable and possible without departing from the scope of protection of the invention. For example, the screw mechanism could be configured in a different manner. A separate gear mechanism part of the screw mechanism that has one of the threads of the screw mechanism and is connected in a rotationally fixed manner to the impulse receiver part could also be provided here. This gear mechanism part, or else the impulse receiver part 41 that is provided with the external thread 60, could also be held so as not to be axially displaceable, and the other gear mechanism part of the screw mechanism could be axially displaceable, wherein the latter could be held by the housing so as to be non-rotatable and guided so as to be axially displaceable.

In the exemplary embodiment shown in FIGS. 1 to 8, it would also be conceivable and possible for the rotor 31 to be configured so as not to be axially displaceable, and for an axially displaceable connection between the rotor 31 and the rotating part 40 of the impulse unit 12 to be provided.

Instead of the rotating part 40 being received in a receptacle space 42 of the impulse receiver unit 41, the impulse receiver part 41 could also be disposed in a sealed receptacle space of the rotating part 40. The sealing elements 48 between the rotating part 40 and the impulse receiver part 41 could also be configured in another manner, for example in the shape of lamellae.

The clamping mechanism activated by the axially displaceable clamping element 11 could also be configured in another manner; for example, other engagement elements instead of clamping balls could also be provided.

### LIST OF REFERENCE SIGNS

1 Housing part

1a Screw flange

2 Housing part

3 Housing part

4 Housing part

5 Screw

6 Screw

7 Insertion nipple

7a Annular groove

7b Stepped face

8 Receptacle opening

9 Drive motor

10 Control unit

11 Clamping element

12 Impulse unit

13 Screw mechanism

14 Drive shaft

15 Nut

16 Trigger pin

17 Limit switch

18 Half ring

19 Half ring

20 Web

21 Groove

22 Groove

23 Clamping ring

23a Ramp

23b Shoulder

24 Clamping ball

25 Washer

26 Spring

27 Aperture ring

27a Protrusion

28 Longitudinal central axis

30 Stator

31 Rotor

32 Permanent magnet

33 Coil

34 Opening

35 Longitudinal central axis

40 Rotating part

41 Impulse receiver part

41a Main part

41b Cover

42 Receptacle space

43 Seal

44 Seal

45 Ball bearing

46 Ball bearing

47 Retaining ring

48 Sealing element

49 Longitudinal central axis

50 Duct

51 Duct

52 Connecting duct

53 Spring

54 Closure member

60 External thread

61 Internal thread

62 Seal

63 Seal

1. A clamping device for clamping an insertion nipple, comprising:
a drive motor having a rotor;
a screw mechanism that is driven by the drive motor;
a clamping element that is axially adjustable by the drive motor via the screw mechanism between an open position in which the insertion nipple is adapted to be introduced into a receptacle opening of the clamping device and extracted therefrom, and a clamping position in which the insertion nipple introduced into the receptacle opening is retained therein;
an impulse unit having a rotating part which is mechanically coupled to the rotor of the drive motor, and from which, for axially adjusting the clamping element via the screw mechanism, a rotary impulse is transmittable, at least once per revolution, to an impulse receiver part of the impulse unit.

2. The clamping device as claimed in claim 1, wherein the impulse receiver part has an external thread which engages with an internal thread of a part that is held in a rotationally fixed of the clamping device.

3. The clamping device as claimed in claim 1, wherein the clamping element is connected to the impulse receiver part so as not to be axially displaceable.

4. The clamping device as claimed in claim 1, wherein the rotor of the drive motor is connected to the rotating part of the impulse unit so as not to be axially displaceable, and is axially displaceable in relation to the stator of the drive motor.

5. The clamping device as claimed in claim 1, further comprising: a sensor for detecting an axial position of the rotating part, wherein the sensor interacts with a drive shaft rigidly connected to the rotating part of the impulse unit or integrally molded on the rotating part, or with a part is connected to said drive shaft so as not to be axially displaceable thereto.

6. The clamping device as claimed in claim 1, wherein the drive motor is a brushless motor, the rotor has permanent magnets and the permanent magnets have a larger axial extent than coils of a stator of the drive motor.

7. The clamping device as claimed in claim 1, wherein the impulse receiver part has a sealed receptacle space in which the rotating part is disposed and in which hydraulic fluid is received, and a drive shaft which is driven by the rotor of the drive motor and drives the rotating part is guided in a sealed manner into the receptacle space through an opening in a base of the impulse receiver part.

8. The clamping device as claimed in claim 1, further comprising a clamping ring which has a ramp with which clamping balls interact, the clamping ring in the clamping position of the clamping element is impinged by the clamping element in relation to the clamping balls and pushes the clamping balls into an annular groove of the insertion nipple.

9. The clamping device as claimed in claim 8, further comprising an aperture ring disposed on a side of the clamping balls that is remote from the impulse unit, and the aperture ring in the open position of the clamping element pushes the clamping balls out of the annular groove of the insertion nipple.

10. The clamping device as claimed in claim 8, wherein the clamping balls on a side that faces the impulse unit are acted on by a washer which is preloaded in relation to the clamping balls by a spring.
